(19) United States
(12) Patent Application Publication
(10) Pub. No.: US 2010/0212513 A1
(43) Pub. Date: Aug. 26, 2010

(54) FRYING-ROASTING DEVICE

(75) Inventors: Chenwei Huang, Fujian (CN); Chunhua Li, Fujian (CN)

Correspondence Address: RABIN & Berdo, PC, 1101 14TH STREET, NW, SUITE 500, WASHINGTON, DC, 20005, US

(73) Assignee: TSANN KUEN(CHINA) ENTERPRISE CO., LTD., Fujian (CN)

(21) Appl. No.: 12/678,818

(22) PCT Filed: Dec. 18, 2007
(86) PCT No.: PCT/CN07/03639

§ 371 Date: Mar. 18, 2010

(30) Foreign Application Priority Data
Dec. 20, 2006 (CN) 200620156562.6

(51) Int. Cl. A47J 37/06

(52) U.S. Cl. 99/377

(57) ABSTRACT

A frying-roasting device is provided. The frying roasting device comprises a lower roasting plate element, an upper roasting plate element and a rotating controlling element. The upper roasting plate element is pivoted to the lower roasting plate element. The upper roasting plate element has an upper pivoting portion. The upper pivoting portion is provided with an upper pivoting opening and at least one stopper projecting from the upper pivoting opening radially. The rotating controlling element is pivoted to the lower roasting plate element and locates in the upper pivoting opening. The rotating controlling element at least comprises a toggle with the first end and the second end that are set oppositely. The first end or the second end selectively leans against the stoppers in the upper pivoting opening so that the position of the upper roasting plate element relative to the lower roasting plate element can be controlled.

### FIELD OF THE INVENTION

The present invention relates to a frying-roasting device, especially to a kind of roasting plate which has two roasting plates clamp opposite with each other upper and lower, furthermore, it relates to a frying-roasting device whose roasting plates are extended with each other at different angles.

### BACKGROUND OF THE INVENTION

The traditional design of frying-roasting device, usually comprising a lower roasting plate element, and an upper roasting plate element which has a back end pivoted to said lower roasting plate element, wherein said lower roasting plate element is disposed with a upward lower frying-roasting surface, and said upper roasting plate element is disposed with a upper frying-roasting surface opposite said lower frying-roasting surface. During the cooking process, firstly put the food on the lower frying-roasting surface, then clamp the upper roasting plate element with said lower roasting plate element, so the food is clamped between said frying-roasting plate for frying and roasting.

In the traditional design of frying-roasting device, said upper roasting plate element can only rotate with said lower roasting plate element and limited in a certain angle, said angle is usually set at an angle slightly over 90°, so it would be convenient to take the food on the lower frying-roasting surface, however, such a design can only fry or roast the food, but it could not adjust or settle the angle between the upper and lower roasting plate element at will, so the user could not determine if the food on the lower frying-roasting surface should contact with the upper frying-roasting surface or not according to his will, especially some kinds of food would not taste nice if pressed by the upper roasting plate, therefore the traditional frying-roasting device would not meet the practical requirement of the customers.

### SUMMARY OF THE INVENTION

The present invention provides a frying-roasting device, it solves the problem of the traditional frying-roasting device wherein the upper and lower frying-roasting surface are unavailable to adjust and settle, and extend to different angles, so the present invention can meet the practical requirement of the customers.

The objective of the present invention is realized as follows: a frying-roasting device, at least comprising:

a lower roasting plate element, comprising a bottom base and a lower roasting plate fixed on said bottom base;

a upper roasting plate element, which is pivoted to said lower roasting plate element, comprising a top base and a upper roasting plate fixed on said top base, said upper roasting plate element comprising a upper pivoting portion pivoted to said lower roasting plate element, there is an upper pivoting opening disposed in said upper pivoting portion, and at least one first stopper projecting from the upper pivoting opening in a radial direction; and

a rotating controlling element is pivoted to the lower roasting plate element and locates in the upper pivoting opening for controlling relative position of said top base and the lower roasting plate of bottom base, wherein said rotating controlling element at least comprising:

a pivot, which is pivoted to said lower roasting plate element;

an elastic unit, which is fixed on said pivot;

a leaning block, which is fixed on said elastic unit; and

a toggle, which is pivoted to said lower roasting plate element, and leans adjacent said leaning block, wherein said toggle comprising a pivoting portion, a first end and a second end, said first end and second end are set by the two sides of said pivoting portion, when said pivot rotates with said lower roasting plate element left and right, said leaning block moves between said first end and said second end and corresponding to said pivoting portion of said toggle for selectively pushing against said first end and second end of said toggle, so said first end and said second end are selectively leaning against said first stopper of said upper pivoting portion.

The frying-roasting device of the present invention, further at least comprising: a second stopper, which is projecting from said upper pivot opening radially, wherein said second stopper is set opposite said first stopper.

The frying-roasting device of the present invention, further at least comprising: a third stopper, which is projecting from said upper pivot opening radially, wherein said third stopper is between said first and second stopper.

The frying-roasting device of the present invention, further at least comprising: an upper supporting shelf, can be relatively pivoted movable to said top base, wherein said upper pivot is set on said upper supporting shelf.

The frying-roasting device of the present invention, further at least comprising:

a shaft base, which is set on said lower roasting plate element; and

a shaft cover, which is fixed on said shaft base for rotatively fastening said upper pivoting portion between said shaft base and shaft cover.

The frying-roasting device of the present invention, wherein said pivot is pivoted to the center point of said shaft base.

The frying-roasting device of the present invention, further at least comprising: a knob coupled to said pivot for controlling said leaning block to move between said first end and second end corresponding to said pivoting portion of said toggle.

The frying-roasting device of the present invention, wherein said toggle is an annular plate of a half circumference.

The frying-roasting device of the present invention, wherein the toggle is set upon said leaning block, when said leaning pushes against said first end of said toggle, said first end moves upwardly corresponding to said pivoting portion, when said leaning block pushes against said second end of said toggle, said second end moves upwardly corresponding to said pivoting portion.

The frying-roasting device of the present invention, wherein said toggle is beneath said leaning block, when said leaning block pushes against said first end of said toggle, said first end moves downwardly corresponding to said pivoting portion, when said leaning block pushes against said second end of said toggle, said second end moves down corresponding to said pivoting portion.

Compared to the traditional technology, the present invention has several advantages as follows: by using above mentioned frying-roasting device, because there is a rotating controlling element arranged on said lower roasting plate element for controlling the position of top base of upper roasting plate element, so the upper roasting plate of top base and the lower roasting plate of bottom base can extends to several different angles, thus it solves the problem of the traditional frying-roasting device wherein the angles of frying-roasting surfaces can not be adjusted and fixed. So compared to other traditional frying-roasting devices, the structure of the present invention can adjust and fix different angles between the two frying-roasting surfaces of the frying-roasting device, thus solves the problems of the traditional frying-roasting device which could not meet the practical requirement of customers.

### BRIEF DESCRIPTION OF THE DRAWINGS

The present invention can be further illustrated by the combination of attached drawings and embodiments.

FIG. 1 is the side view of the frying-roasting device of the preferred embodiment of the present invention.

FIG. 2 is the perspective view of the frying-roasting device of the preferred embodiment of the present invention.

FIG. 3 is the partial perspective view of the frying-roasting device of the preferred embodiment of the present invention.

FIG. 4 is the schematic view of the frying-roasting device of the preferred embodiment of the present invention wherein the upper roasting plate element is opened and completely extended.

FIG. 5 is the schematic view of the frying-roasting device of the preferred embodiment of the present invention wherein the upper roasting plate element is opened and half-extended, the upper roasting plate is locked joint oppositely with the lower roasting plate.

FIG. 6A is the schematic view of the frying-roasting device of the preferred embodiment of the present invention wherein the upper roasting plate element is opened and half-extended, and the upper roasting plate moves corresponding to the lower roasting plate.

FIG. 6B is the schematic view of the frying-roasting device of the preferred embodiment of the present invention wherein the upper roasting plate element is opened and set upon the lower roasting plate element parallelly.

### DETAILED DESCRIPTION OF THE EMBODIMENTS

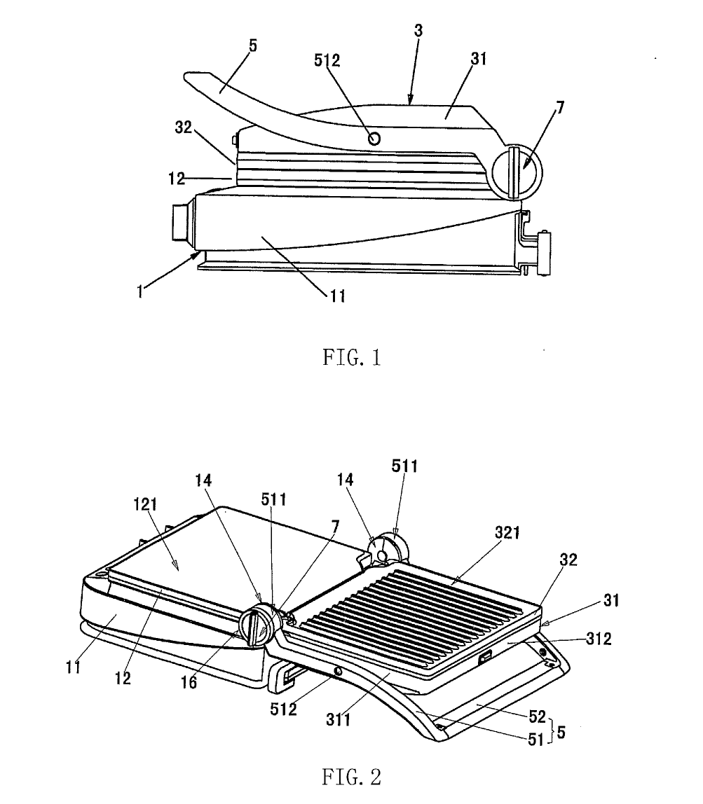

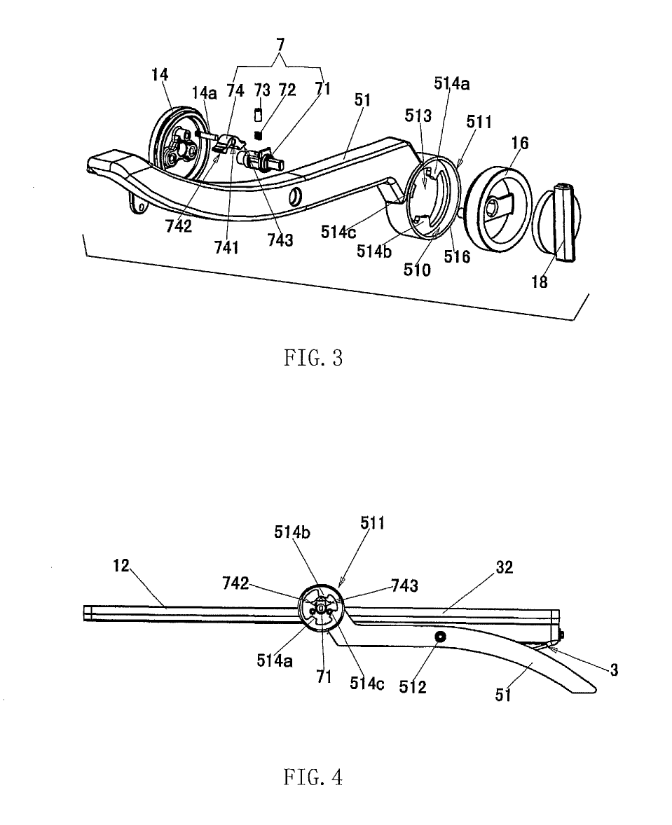

Please refer to FIG. 1, FIG. 2 and FIG. 3, those respectively illustrate the side, perspective and partial perspective view of the preferred embodiment of the frying-roasting device of the present invention, wherein FIG. 1 shows the frying-roasting device of a clamp status, FIG. 2 shows the frying-roasting device of a completely extended status, FIG. 3 shows the relationship of the rotating controlling element of the frying-roasting device assembles with other fitting units. The directions mentioned below accords to the frying-roasting device of completely extended status, meanwhile configure one side of rotating controlling element 7 as the rear direction, that is, the left side in FIG. 1 is the front of the frying-roasting device, while the right side in FIG. 1 is the rear of said frying-roasting device. Said frying-roasting device comprising a lower roasting plate element 1, an upper roasting plate element 3 and a rotating controlling element 7. In the present embodiment, the lower roasting plate element 1 comprising a bottom base 11 and a lower roasting plate 12 set on the bottom base 11, wherein said lower roasting plate 12 has a lower frying-roasting surface 121.

The upper roasting plate element 3 of the present embodiment comprising: a top base 31 pivoted to the lower roasting plate element 1 and an upper roasting plate 32 fixed on said top base 31. An upper supporting shelf 5 is relatively pivoted movable fixed to said top base, wherein top base 31 has two first sides wall 311 which are spaced left and right and a second side walls which are spaced front and rear. In the present embodiment, said upper roasting plate and top base 31 are fastened together, further has an upper frying-roasting surface 321 which is disposed with a plurality of channels.

The upper supporting shelf 5 has two connecting sections 51 arranged intervally by the left and right side of top base 31 and a pulling section 52 connected between said connecting sections 51. Said connecting sections 51 both have an upper pivoting part 511 set by the left and right sides and extend to the rear of the frying-roasting device, and an assembling part 512 located in the middle and pivoted to the first side wall 311 of said top base 31. Wherein the upper pivoting part 511 of the connecting section 51 is disposed with a circumferential wall 516 which surrounds a central axis and is configured with a upper pivoting opening 513, said upper pivoting part 511 locates on the shaft base 14 of said lower roasting plate element 1 and fixed between the shaft cover 16 of the shaft base 14, for rotatively fixing said upper pivoting part 511 between the shaft base 14 and shaft cover 16, wherein the shaft base 14 is fixed on the lower roasting plate element 1 by molding in one or other manners (such as welding or screw jointing), said shaft cover 16 is removable fixed on the shaft base 14. moreover, said upper pivoting part 511 has a first stopper 514a\ second stopper 514b and third stopper 514c projected from the inner circumference surface 510 of the self-encircling wall 516 in a center axial direction, as showed in FIG. 3, wherein said second stopper 514b is placed opposite the first stopper 514a, the circumferential angle of the first and second stopper is about 180°, the third stopper 514c is placed between the first and second stopper 514a and 514b, the circumferential angle of the third stopper and first or second stopper is about 90°.

Please refer to FIG. 3, the rotating controlling element 7 of the present embodiment is pivoted to the shaft base 14 of lower roasting plate element 1, and placed in the upper pivoting opening 513 of the connection section 51, for controlling the relative position of the upper roasting plate 32 of the top base 31 and the lower roasting plate 12 of the bottom base 11. The rotating controlling element 7 comprising a pivot 71\ an elastic unit\ a leaning block 73 and a toggle 74, wherein the pivot 71 is pivoted to the middle point of shaft base 14 of lower roasting plate element 1, and rotatively fastened between the shaft base 14 and shaft cover 16. The elastic unit 72 is fixed on the pivot 71, leaning block 73 is fixed on said elastic unit 72, wherein the elastic unit 72 provides a elastic force to the leaning block 73. The toggle 74 is pivoted to the shaft base 14 of the lower roasting plate element 1, and leans adjacent to the leaning block 73. In the present embodiment, said toggle 74 is placed on the leaning block 73, wherein said toggle has a pivoting portion 741\ a first end 742 and a second end 743, said first end and second end 743 is arranged by the two sides of said pivoting portion 741 oppositely, said pivot 71 can relatively rotate with lower roasting plate element 1 left and right, so the leaning block 73 moves between said first end 742 and said second end 743 and corresponding to said pivot connecting 741 of said toggle 74 for selectively pushing against said first end 742 and second end 743 of said toggle 74, so said first end 742 and said second end 743 are selectively leaning against said first stopper 514a\ second stopper 514b or third stopper 514c of said upper pivoting portion 511 of connecting section 51. When the leaning block 73 pushes against said first end 742 of said toggle 74, said first end 742 moves upwardly corresponding to said pivoting portion 741, and said second end 743 moves downwardly said pivoting portion 741 and leans against pivot 71; when said leaning block 73 pushes against said second end 743 of said toggle 74, said second end 743 moves upwardly corresponding to said pivoting portion 741, and said first end 742 moves downwardly corresponding to said pivoting portion 741 and leans against pivot 71. There is an alternative selection: if the toggle 74 is placed beneath the leaning block 73, when said leaning block 73 pushes against said first end 742 of said toggle 74, said first end 742 moves corresponding to said pivoting portion 741, and said second end 743 moves upwardly corresponding to said pivoting portion 741 and leans against pivot 71; when the leaning block 73 pushes against said second end 743 of said toggle 74, said second end 743 moves downwardly corresponding to said pivoting portion 741, and said first end 742 moves upwardly corresponding to said pivot connecting 741 and leans against pivot 71. Furthermore, there is a knob 18 which is coupled to pivot 71 and disposed on the shaft cover 16, so the users can conveniently rotate the pivot 71 left and right, and the leaning block 73 can be controlled to move between the first end 742 and second end 743 and corresponding to the pivot connecting 741 of toggle 74. In the present embodiment, the pivoting portion 741 of toggle 74 is a hole, said hole is pivoted to the bolt 14a on the shaft base 14, but not limited to the above mentioned, said pivoting portion can also be a bolt, which is pivoted to the hole of shaft base 14. Moreover, in the present embodiment, the toggle 74 is an annular plate with a half circumference, but not limited to that, said toggle can also be a flat plate, as long as the first end 742 and second end 743 set oppositely by the two sides of pivoting portion 741, and be pushed by the leaning block 73 to move up and down corresponding to the pivoting portion 741.

Please refer to FIG. 4, said FIG. 4 shows schematic view of the upper roasting plate element 3 being opened and completely extended. Because when the first and second end 742\743 of toggle 74 of rotating controlling element 7 are placed at the same height level, they would not leans against the first stopper 514a\ second stopper 514b or third stopper 514c of the upper pivoting portion 511 of connecting section 51, so at this moment the upper roasting plate element 3 can rotate corresponding to the lower roasting plate element 1 at an angle about 180°.

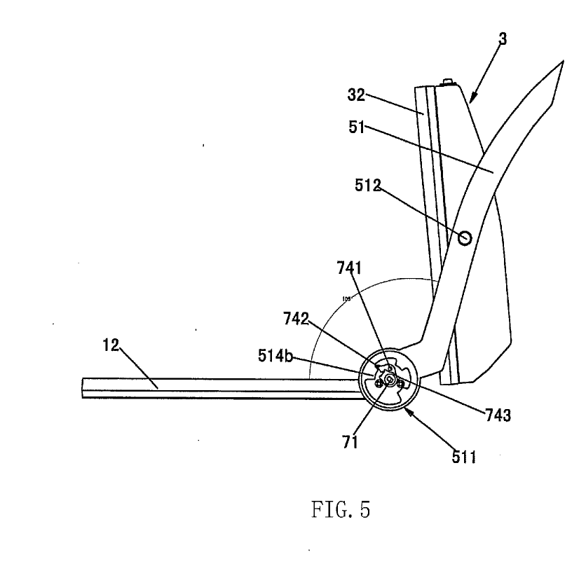

Please refer to FIG. 5, said FIG. 5 is the schematic view of the upper roasting plate element being opened and half-extended. Firstly rotate the pivot 71 of the rotating controlling element 7 corresponding to the left of shaft base 14 of the lower roasting plate element 1 about 45°, at this moment the first end 742 moves upwardly to a new position corresponding to said pivoting portion 741, said second part 743 would move downwardly and leans against the pivot 71, then the upper roasting plate element moves so the second stopper 514b of the upper pivoting portion 511 of the connecting section 51 of top base 41 can lean against the first end 742, so that the upper roasting plate element 3 is fixed at a half-opened status. At this moment the angle between the connecting section 51 of upper supporting shelf 5 and the lower roasting plate 12 of bottom base 11 is about 105°, while the angle between the upper roasting plate 32 of top base 31 and the lower roasting plate 12 of bottom base 11 is about 90°, that is, the upper roasting plate 32 is pivoted movable corresponding the connecting section 51 at an angle about 15°. It is worth noticing that, the upper roasting plate 32 can also be pivoted movable corresponding to the connecting section 51 at other angles or do not remove, so that the angles between the upper roasting plate 32 and lower roasting plate 12 can be different.

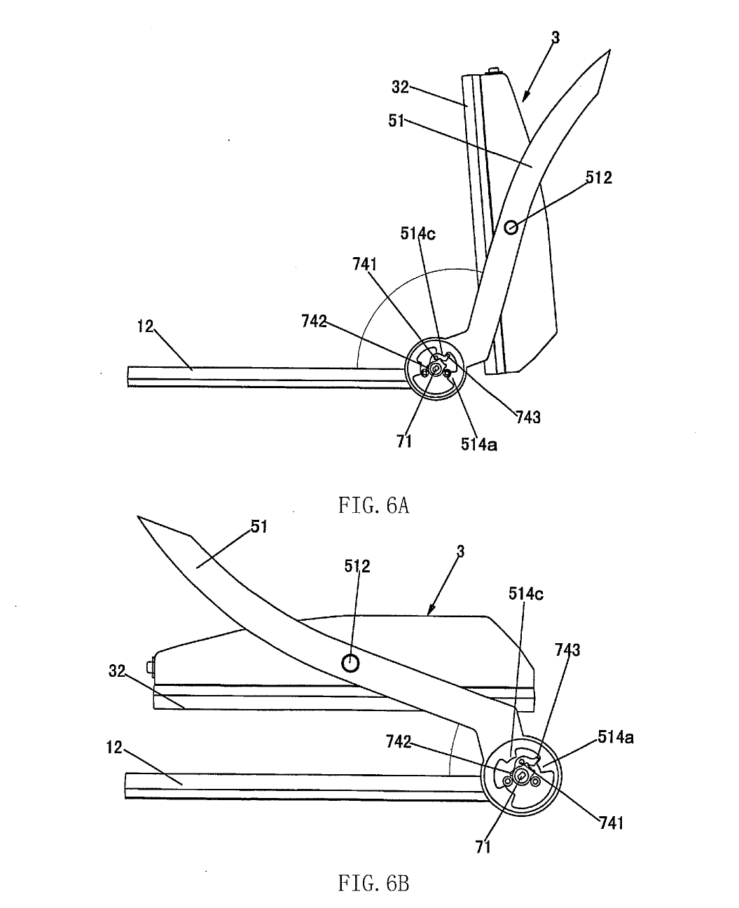

Please refer to FIG. 6A and FIG. 6B, which are two schematic views of the upper roasting plate element is opened and half-extended. Firstly open the upper roasting plate 3 and kept half-extended (as illustrated in FIG. 6A), then rotate the pivot 71 of the rotating controlling element 7 corresponding to the shaft base 14 of lower roasting plate element 1 to the right about 45°, at the same time the second end 743 moves upwardly corresponding to said pivoting portion 741 and leans against the third stopper 514c, then moves the upper roasting plate element 3 so the first stopper 514a of the upper pivoting portion 511 of the connecting section 51 of upper supporting shelf 5 leans against the second end 743, further the first end 742 moves downwardly and leans against the pivot 71, so that the upper roasting plate element3 can be fixed at a half-extended status (as illustrated in FIG. 6B). Meanwhile the angle between the connecting section 51 of upper supporting shelf 5 and the lower roasting plate 12 of the bottom 11 is about 20°, the upper roasting plate 32 of top base 31 is parallely spaced with the lower roasting plate 12 of the bottom base 11 at a certain distance, that is, the upper roasting plate 32 can be pivoted movable corresponding to the connecting section 51 at an angle about 20°. It is worth noticing that, if the angles between the lower roasting plate element 1 and the upper roasting plate 3 element needed to be set with other angles, the other stopper will be additionally disposed on the upper pivoting portion 511 of the connecting section 51, so that when the first end 742 of the toggle 74 or the second end 743 leans against said stopper, the angles between the lower roasting plate element 1 and upper roasting plate element 3 can extended to other angles. Furthermore, by changing the angle of the upper roasting plate element 32 is pivoted movable corresponding to the connecting section 51, the angle between the upper roasting plate 32 and lower roasting plate 12 can be changed. In addition, the present embodiment can also arrange two rotating controlling elements 7 by the left and right sides of said upper roasting plate 3, so that said upper roasting plate element 3 can be more firmly rotated, because only one rotating controlling element 7 can meet the above effect, so it is not necessary to arrange two rotating controlling elements 7.

To sum up, in the frying-roasting device of the present invention, its structural feature is: there is a rotating controlling element set on the lower roasting plate element, and said rotating controlling element is used to control the position of upper roasting plate element, so there will be different angles between the upper roasting plate of top base and lower roasting plate of bottom base, thus it solves the problems of the traditional frying-roasting device wherein the frying-roasting surface are unavailable to adjust and settle, and extended to different angles. Compared to other traditional frying-roasting devices, the structure of the upper and lower frying-roasting surfaces of the frying-roasting device of the present invention can be extended to different angles, so it solves the problems of the traditional frying-roasting device which could not meet the practical requirement of customers.

Although the present invention has been described with reference to the preferred embodiments thereof and the best modes for carrying out the invention, it is apparent to those skilled in the art that a variety of modifications and changes may be made without departing from the scope of the present invention which is intended to be defined by the appended claims.

### INDUSTRIAL APPLICABILITY

The advantage of the frying-roasting device of the present invention lies in that: the upper roasting plate element can be opened corresponding to the lower roasting plate element, and the angles between them can be extended from 0° to 180°, further the upper roasting plate element can be fixed corresponding to the angle and position of the lower roasting plate element, thus the upper and lower frying-roasting surfaces are set upwardly, it may save time by simultaneously put food on said roasting plate element, and there will be different angles between the upper and lower frying-roasting surfaces for preventing the food be pressed by the upper frying-roasting surface, therefore such a device has a good industrial applicability.

What is claimed is:

1. A frying-roasting device, wherein it comprising:
a lower roasting plate element, comprising a bottom base and a lower roasting plate fixed on said bottom base;
a upper roasting plate element, which is pivoted to said lower roasting plate element, comprising a top base and a upper roasting plate fixed on said top base, said upper roasting plate element comprising a upper pivoting portion pivoted to said lower roasting plate element, there is an upper pivoting opening disposed in said upper pivoting portion, and at least one first stopper projecting from the upper pivoting opening in a radial direction; and
a rotating controlling element is pivoted to the lower roasting plate element and locates in the upper pivoting opening for controlling relative position of said top base and the lower roasting plate of bottom base, wherein said rotating controlling element at least comprising:
a pivot, which is pivoted to said lower roasting plate element;
an elastic unit, which is fixed on said pivot;
a leaning block, which is fixed on said elastic unit; and
a toggle, which is pivoted to said lower roasting plate element, and leans adjacent said leaning block, wherein said toggle comprising a pivoting portion, a first end and a second end, said first end and second end are set by the two sides of said pivoting portion, when said pivot rotates with said lower roasting plate element left and right, said leaning block moves between said first end and said second end and corresponding to said pivoting portion of said toggle for selectively pushing against said first end and second end of said toggle, so said first end and said second end are selectively leaning against said first stopper of said upper pivoting portion.

2. A frying-roasting device according to claim 1, wherein, it further comprising:
a second stopper, which is projecting from said upper pivot opening radially, wherein said second stopper is set opposite said first stopper.

3. A frying-roasting device according to claim 2, wherein, it further comprising a third stopper, which is projecting from said upper pivot opening radially, wherein said third stopper is between said first and second stopper.

4. A frying-roasting device according to claim 3, wherein, it further comprising: an upper supporting shelf is relatively pivoted movable to said top base, wherein said upper pivot is set on said upper supporting shelf.

5. A frying-roasting device according to claim 4, wherein, it further comprising:
a shaft base, which is set on said lower roasting plate element; and
a shaft cover, which is fixed on said shaft base for rotatively fastening said upper pivoting portion between said shaft base and shaft cover.

6. A frying-roasting device according to claim 5, wherein, said pivot is pivoted to the center point of said shaft base.

7. A frying-roasting device according to claim 6, wherein, it further comprising:
a knob coupled to said pivot for controlling said leaning block to move between said first end and second end corresponding to said pivoting portion of said toggle.

8. A frying-roasting device according to claim 6, wherein, said toggle is an annular plate of a half circumference.

9. A frying-roasting device according to claim 1, wherein: the upper roasting plate element can be opened corresponding to the lower roasting plate element, and the angles between them can be extended from 0° to 180°, further the upper roasting plate element can be fixed corresponding to the angle and position of the lower roasting plate element.
